(19) United States
(12) Patent Application Publication
(10) Pub. No.: US 2010/0122226 A1
(43) Pub. Date: May 13, 2010

(54) LAYOUT DENSITY VERIFICATION SYSTEM AND LAYOUT DENSITY VERIFICATION METHOD

(75) Inventor: Katsuhisa HIROTA, Kanagawa (JP)

Correspondence Address: YOUNG & THOMPSON, 209 Madison Street, Suite 500, Alexandria, VA, 22314, US

(73) Assignee: NEC ELECTRONICS CORPORATION, Kanagawa (JP)

(21) Appl. No.: 12/612,955

(22) Filed: Nov. 5, 2009

(30) Foreign Application Priority Data
Nov. 7, 2008 (JP) 2008-286539

(51) Int. Cl. G06F 17/50

(52) U.S. Cl. 716/5; 716/17

(57) ABSTRACT

A layout density verification system has: a model generation unit configured to generate a macro model for use in metal density check, with respect to a macro included in a layout data; and a metal density check unit configured to perform the metal density check of the layout data by using the macro model. The macro model includes: an inner region; and an outer region surrounding the inner region and located between the inner region and an outer boundary of the macro. The inner region is masked by metal while a metal layout within the outer region is maintained. A width of the outer region inward from the outer boundary of the macro is equal to or larger than a width of one side of a window as a check unit at a time of the metal density check.

### INCORPORATION BY REFERENCE

This application is based upon and claims the benefit of priority from Japanese patent application No. 2008-286539, filed on Nov. 7, 2008, the disclosure of which is incorporated herein in its entirety by reference.

### BACKGROUND OF THE INVENTION

1. Field of the Invention

The present invention relates to a layout density verification technique that verifies metal density in a layout of a semiconductor integrated circuit.

2. Description of Related Art

In order to suppress dishing and the like during CMP (Chemical Mechanical Polishing) in a manufacturing process, “dummy metal fill” is often performed at a designing stage. Specifically, metal density is checked based on a layout data of a design circuit and dummy metals are inserted into a low metal density region. Macro models for use in the metal density check such as shown in FIGS. 1 to 3 are known.

FIG. 1 shows an example of the macro model for use in the metal density check. In the example shown in FIG. 1, the whole of macro is covered by metal. At the time of metal density check, the metal density within the macro is calculated to be 100%. In this case, however, actual metal density is not reflected in the macro model at all. Therefore, sufficient dummy metals are not inserted around the macro, which causes defects after the semiconductor chip is manufactured.

FIG. 2 shows another example of the macro model for use in the metal density check. In the example shown in FIG. 2, all of metal layout within the macro is expanded to be seen. In this case, estimation accuracy of the metal density is improved. However, since the complicated metal layout all is expanded, memory usage, computer load and computation time required for the metal density check are increased remarkably.

FIG. 3 shows still another example of the macro model for use in the metal density check. In the example shown in FIG. 3, the macro is divided into a plurality of regions, and the metal densities in respective regions are represented in a table form. If a check window at the time of the metal density check does not accord with a boundary of each region, a calculation error may be caused.

FIG. 4 shows an example of a macro model for use in wiring DRC (Design Rule Check). As shown in FIG. 4, the layout can be seen for a certain distance from a macro boundary. The distance from the macro boundary is about an inter-wiring spacing specified by the design rule and is much smaller than the check window at the time of the metal density check.

As a related technique, Japanese Laid-Open Patent Application JP-2005-228208 discloses a layout density verification method for a chip. This density verification method is for a layout for arranging a macro showing various circuit parts on a chip. The method includes: a step of forming layout data of the macro to be arranged on the chip, in which data density of a specified layer of the macro is calculated and assigned, as a parameter, to a file including terminal information or size information of the macro formed in the step of forming the layout data of the macro in association with the macro; and a layout step of arranging the macro on the chip based on the terminal information or size information of the macro, in which the verification of density on the chip reflecting the density of the macro is performed in reference to the parameter.

### SUMMARY

In an aspect of the present invention, a layout density verification system is provided. The layout density verification system has: a model generation unit configured to generate a macro model for use in metal density check, with respect to a macro included in a layout data; and a metal density check unit configured to perform the metal density check of the layout data by using the macro model. The macro model includes: an inner region; and an outer region surrounding the inner region and located between the inner region and an outer boundary of the macro. The inner region is masked by metal while a metal layout within the outer region is maintained. A width of the outer region inward from the outer boundary of the macro is equal to or larger than a width of one side of a window as a check unit at a time of the metal density check.

In another aspect of the present invention, a layout density verification method is provided. The layout density verification method includes: generating a macro model for use in metal density check, with respect to a macro included in a layout data; and performing the metal density check of the layout data by using the macro model. The macro model includes: an inner region; and an outer region surrounding the inner region and located between the inner region and an outer boundary of the macro. The inner region is masked by metal while a metal layout within the outer region is maintained. A width of the outer region inward from the outer boundary of the macro is equal to or larger than a width of one side of a window as a check unit at a time of the metal density check.

In still another aspect of the present invention, a program recorded on a computer-readable recording medium and, when executed, causing a computer to perform layout density verification processing is provided. The layout density verification processing includes: generating a macro model for use in metal density check, with respect to a macro included in a layout data; and performing the metal density check of the layout data by using the macro model. The macro model includes: an inner region; and an outer region surrounding the inner region and located between the inner region and an outer boundary of the macro. The inner region is masked by metal while a metal layout within the outer region is maintained. A width of the outer region inward from the outer boundary of the macro is equal to or larger than a width of one side of a window as a check unit at a time of the metal density check.

According to the present invention, accuracy of the metal density check is enhanced. Moreover, memory usage, computer load and computation time required for the metal density check are reduced.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 schematically shows an example of a macro model for use in metal density check;

FIG. 2 schematically shows another example of a macro model for use in metal density check;

FIG. 3 schematically shows still another example of a macro model for use in metal density check;

FIG. 4 schematically shows an example of a macro model for use in wiring DRC;

FIG. 5 is a block diagram showing a configuration of a layout density verification system according to an embodiment of the present invention;

FIG. 6 schematically shows a macro model for use in metal density check according to an embodiment of the present invention;

FIG. 7 is a flow chart showing an example of layout density verification processing according to an embodiment of the present invention;

FIG. 8 is a flow chart showing a method of generating the macro model according to an embodiment of the present invention;

FIG. 9 schematically shows an internal structure of a macro;

FIG. 10 schematically shows the macro model in which an inner region and an outer region are set;

FIG. 11 schematically shows the macro model in which metals within the inner region are removed; and

FIG. 12 schematically shows the macro model in which metals are converted into OBS figures.

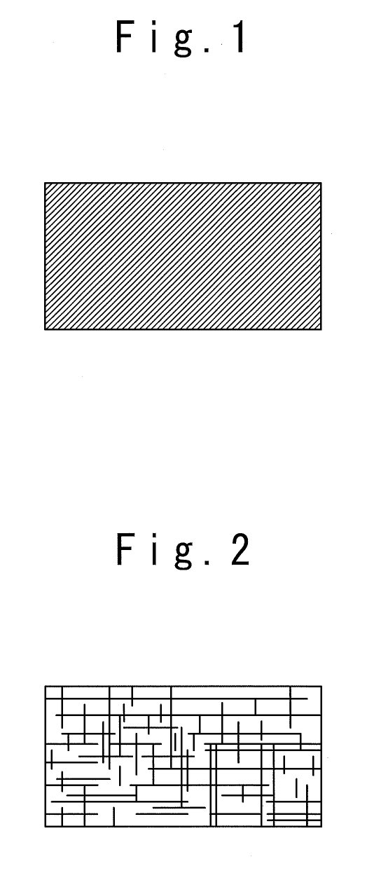

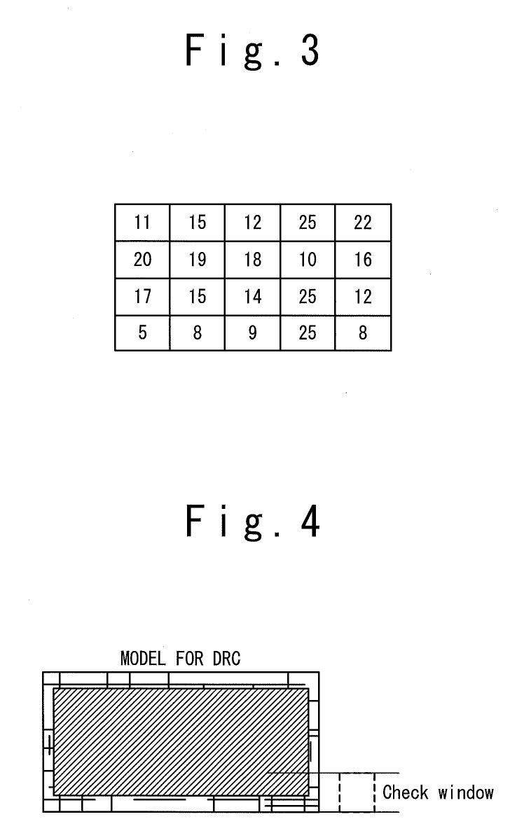

### DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

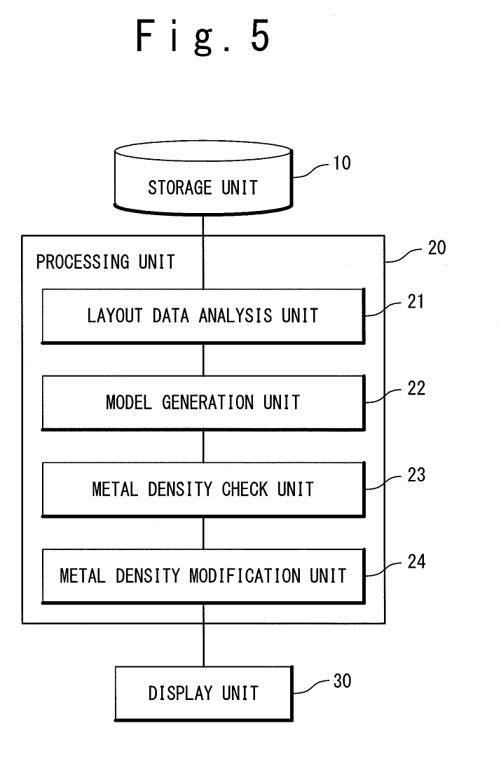

FIG. 5 is a block diagram showing a configuration of a layout density verification system according to the present embodiment. The layout density verification system has a storage unit 10, a processing unit 20 and a display unit 30.

Stored in the storage unit 10 are a layout data of a semiconductor integrated circuit, processing result data and the like. The storage unit 10 is exemplified by a semiconductor memory, a hard disk drive and the like. The display unit 30 displays the processing result data. The display unit 30 is exemplified by a liquid crystal display device and the like.

The processing unit 20 includes a CPU (Central Processing Unit) or a microprocessor. The processing unit 20 performs layout density verification processing according to the present embodiment, based on the layout data stored in the storage unit 10. Specifically, the processing unit 20 generates a macro model with respect to a macro included in the layout data and performs metal density check of the layout data by using the macro model. The metal density check is to check the metal density in a predetermined region.

As shown in FIG. 5, the processing unit 20 has function blocks such as a layout data analysis unit 21, a model generation unit 22, a metal density check unit 23 and a metal density modification unit 24.

The layout data analysis unit 21 analyzes the layout data to extract the number and locations of the macros and a shape of each macro included in the layout data. For example, the layout data analysis unit 21 extracts coordinates of vertices (corners) of each macro from the layout data and determines the shape of each macro based on the coordinates data. For example, when the number of vertices of a macro is four, the layout data analysis unit 21 determines the shape of this macro to be rectangle.

The model generation unit 22 generates a macro model for use in the metal density check, with respect to each macro included in the layout data.

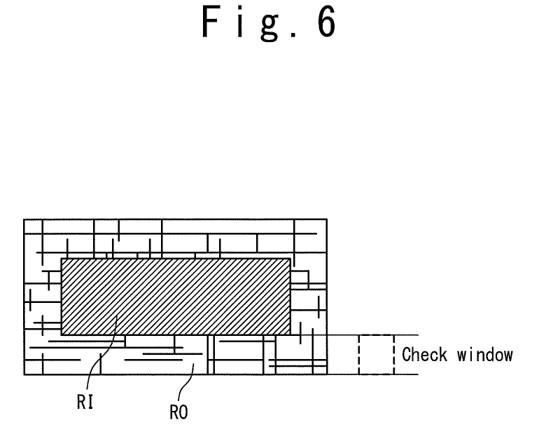

FIG. 6 schematically shows the macro model according to the present embodiment. As shown in FIG. 6, the macro model according to the present embodiment includes an inner region RI and an outer region RO. The outer region RO surrounds the inner region RI and is located between the inner region RI and an outer boundary (outer border) of the macro. As shown in FIG. 6, the whole of the inner region RI is masked by metal. That is, the layout within the inner region RI is hidden. On the other hand, in the outer region RO, the metal layout is maintained and can be recognized. That is, the metal layout within the outer region RO is not hidden and can be seen.

Hereinafter, a window that is used as a check unit at the time of the metal density check is referred to as a “check window”, and a width of one side of the check window is referred to as a “window width”. Typically, a shape of the check window is square and the window width is predetermined in specification. According to the present embodiment, a width of the outer region RO inward from the macro outer boundary is designed to be equal to or larger than the window width. In the example shown in FIG. 6, the width of the outer region RO inward from the macro outer boundary is set to be equal to the window width. In a case where the width of the outer region RO exceeds the window width, the excess amount is preferably smaller than the window width. The reason is that unnecessary enlargement of the outer region RO leads to increase in computation load in the metal density check.

The model generation unit 22 ensures a predetermined distance inward from the macro outer boundary to define the inner region RI and the outer region RO, with respect to each macro included in the layout data. As mentioned above, the predetermined distance is equal to or more than the window width. Then, the model generation unit 22 masks the whole of the inner region RI with metal. Consequently, the model generation unit 22 generates the macro model shown in FIG. 6.

As a modification example, the model generation unit 22 may generate a macro model in the table form as shown in FIG. 3, when the macro shape is rectangle. In the macro model shown in FIG. 3, the macro is divided into a plurality of regions and the metal densities in respective regions are represented in the table form. That is to say, when the macro shape is a simple rectangle, the model generation unit 22 selects the metal density check in the table form. In this case, the metal density check can be performed easily.

On the other hand, when the macro shape is different from rectangle, the model generation unit 22 generates the macro model shown in FIG. 6. When the macro shape is not rectangle, it is often a polygonal shape other than rectangle. If the macro model in the table form is applied to the polygonal shape macro, computational errors are likely to occur. For example, one window may straddle over three different regions and, in this case, it is not possible to correctly calculate the metal density in one region. For this reason, the model generation unit 22 generates the macro model shown in FIG. 6 at least when the macro shape is different from rectangle.

The metal density check unit 23 performs the metal density check of the layout data by using the above-described macro model. More specifically, the metal density check unit 23 uses the check window to perform the metal density check window size by window size. The window size is a size of a region of the check window. For example, the metal density check unit 23 repeatedly performs the metal density check window size by window size along row or column from the left-top to the right-bottom of the layout. At this time, the metal density check unit 23 treats the metal density in the inner region RI of the macro as 100%. The metal density check unit 23 judges whether or not the metal density meets a predetermined criterion (condition). Moreover, the metal density check unit 23 generates the processing result data indicating results of the metal density check and stores it in the storage unit 10.

If the metal density does not meet the predetermined criterion, the metal density modification unit 24 modifies the metal density. More specifically, the metal density modification unit 24 modifies the metal layout in accordance with a predefined rule to update the layout data.

According to the present embodiment, as described above, the macro model for use in the metal density check is so generated as to include the inner region RI and the outer region RO. In the outer region RO, the metal layout is not hidden and can be recognized. Furthermore, the width of the outer region RO is equal to or more than the width of one side of the check window. It is thus possible to correctly calculate the metal density around the macro at the time of the metal density check. As a result, the accuracy of the metal density check is enhanced and yield is improved.

Moreover, the inner region RI is masked by metal. In other words, the layout in a region where the check is unnecessary is hidden and cannot be seen. Therefore, the data amount of the macro model is greatly reduced. As a result, the memory usage, computer load and computation time required for the metal density check are reduced.

It should be noted that the above-described layout density verification processing according to the present embodiment is typically achieved by the processing unit 20 (computer) executing a program. The program, which may be recorded on a computer-readable recording medium, is executed by the computer.

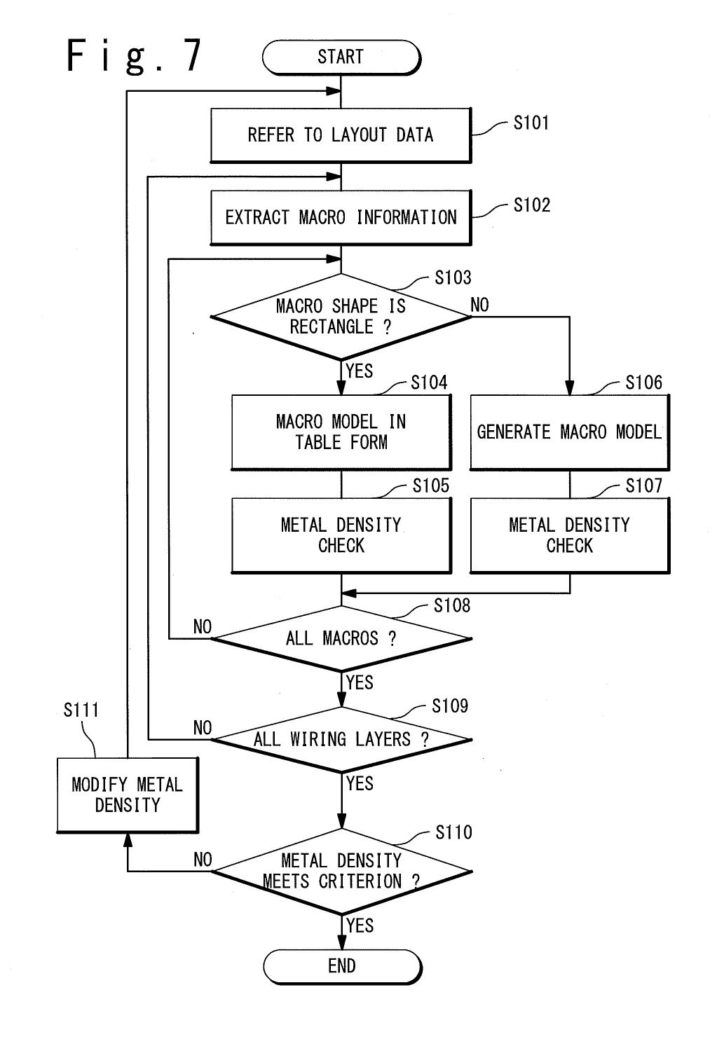

One example of the layout density verification processing will be described with reference to FIG. 7.

Step S101:

The layout data analysis unit 21 refers to the layout data. The layout data analysis unit 21 reads the layout data stored in the storage unit 10.

Step S102:

Based on the layout data, the layout data analysis unit 21 obtains macro information and shape information with respect to each wiring layer. The macro information includes the number of macros included in the layout data. The shape information includes coordinates information indicating positions of vertices (corners) of each macro. The layout data analysis unit 21 obtains the macro information and the shape information from the lowest layer among wiring layers.

Step S103:

The layout data analysis unit 21 judges whether or not the macro shape is rectangle with respect to each macro. For example, when the number of vertices of a macro is four, the layout data analysis unit 21 determines the shape of this macro to be rectangle.

Step S104:

In the case where the macro shape is rectangle (Step S103; Yes), the model generation unit 22 generates the macro model in the table form as shown in FIG. 3. A size of each region of the table may be equal to the window size.

Step S105:

The metal density check unit 23 performs the metal density check and stores the processing result data in the storage unit 10.

Step S106:

In the case where the macro shape is not rectangle (Step S103; No), the model generation unit 22 generates the macro model shown in FIG. 6. When the macro shape is not rectangle, it is often a polygonal shape other than rectangle.

Step S107:

The metal density check unit 23 performs the metal density check and stores the processing result data in the storage unit 10.

Step S108:

The metal density check unit 23 performs the same processing with respect to all the macros in a wiring layer.

Step S109:

When the metal density check of the layout in a wiring layer is completed, the processing transits to an upper wiring layer.

Step S110:

If the metal density meets the predetermined criterion in all the wiring layers, the processing is finished.

Step S111:

If the metal density does not meet the predetermined criterion, the metal density modification unit 24 modifies the metal density. More specifically, the metal density modification unit 24 modifies the metal layout in accordance with a predefined rule to update the layout data. After that, the processing returns back to Step S101.

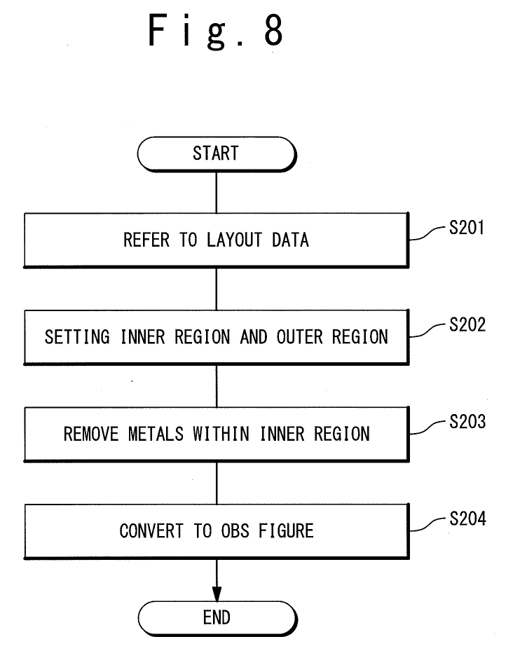

A method of generating the macro model according to the present embodiment will be described with reference to FIG. 8.

Step S201:

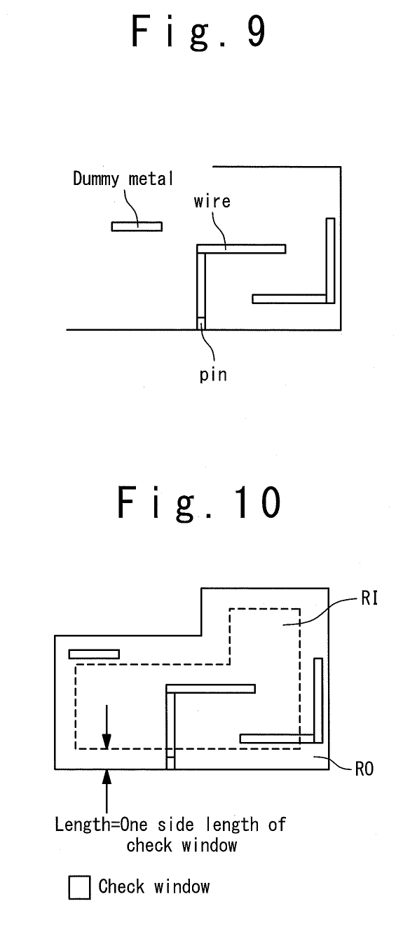

The layout data analysis unit 21 analyzes the layout data to extract the number and locations of the macros and the macro shape. At this time, the layout data analysis unit 21 recognizes an internal structure of each macro. As shown in FIG. 9, the macro includes pins, wirings, dummy metals and the like.

Step S202:

As shown in FIG. 10, the model generation unit 22 ensures a predetermined distance inward from the macro outer boundary to define the inner region RI and the outer region RO. As mentioned above, the predetermined distance is equal to or more than the window width.

Step S203:

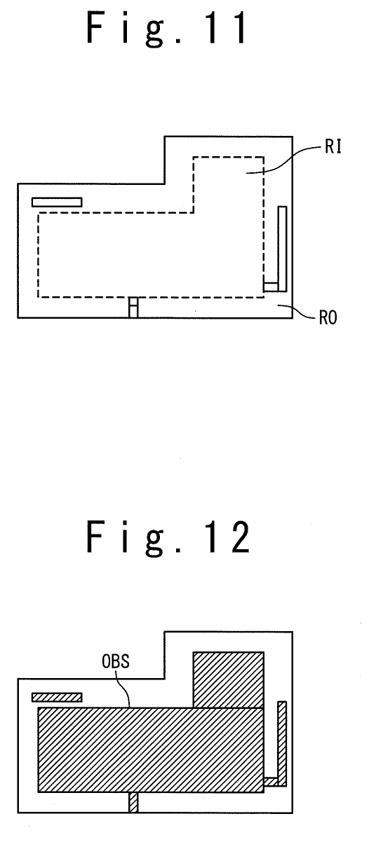

The model generation unit 22 removes the metal layout within the inner region RI. Here, as shown in FIG. 11, the model generation unit 22 removes the wirings and dummy metals within the inner region RI.

Step S204:

As shown in FIG. 12, the model generation unit 22 converts the inner region RI and remaining metals into OBS figures. The OBS figure indicates a wiring prohibited region. In this manner, the macro model according to the present embodiment is completed.

According to the present embodiment, as described above, the macro model for use in the metal density check is so generated as to include the inner region RI and the outer region RO. In the outer region RO, the metal layout is not hidden and can be recognized. Furthermore, the width of the outer region RO is equal to or more than the width of one side of the check window. It is thus possible to correctly calculate the metal density around the macro at the time of the metal density check. As a result, the accuracy of the metal density check is enhanced and yield is improved.

Moreover, the inner region RI is masked by metal. In other words, the layout in a region where the check is unnecessary is hidden and cannot be seen. Therefore, the data amount of the macro model is greatly reduced. As a result, the memory usage, computer load and computation time required for the metal density check are reduced.

It is apparent that the present invention is not limited to the above embodiments and may be modified and changed without departing from the scope and spirit of the invention.

What is claimed is:

1. A layout density verification system comprising:
a model generation unit configured to generate a macro model for use in metal density check, with respect to a macro included in a layout data; and
a metal density check unit configured to perform the metal density check of said layout data by using said macro model,
wherein said macro model includes:
an inner region; and
an outer region surrounding said inner region and located between said inner region and an outer boundary of said macro,
wherein said inner region is masked by metal while a metal layout within said outer region is maintained, and
a width of said outer region inward from said outer boundary of said macro is equal to or larger than a width of one side of a window as a check unit at a time of said metal density check.

2. The layout density verification system according to claim 1, further comprising a layout data analysis unit configured to judge, based on said layout data, whether a shape of said macro is rectangle or not,
wherein when said shape of said macro is different from rectangle, said model generation unit generates said macro model.

3. The layout density verification system according to claim 2,
wherein when said shape of said macro is rectangle, said model generation unit generates another macro model instead of said macro model,
wherein in said another macro model, said macro is divided into a plurality of regions and respective metal densities in said plurality of regions are represented in a table form.

4. A layout density verification method comprising:
generating a macro model for use in metal density check, with respect to a macro included in a layout data; and
performing the metal density check of said layout data by using said macro model,
wherein said macro model includes:
an inner region; and
an outer region surrounding said inner region and located between said inner region and an outer boundary of said macro,
wherein said inner region is masked by metal while a metal layout within said outer region is maintained, and
a width of said outer region inward from said outer boundary of said macro is equal to or larger than a width of one side of a window as a check unit at a time of said metal density check.

5. The layout density verification method according to claim 4, further comprising: judging, based on said layout data, whether a shape of said macro is rectangle or not,
wherein when said shape of said macro is different from rectangle, said generating said macro model is performed.

6. The layout density verification method according to claim 5, further comprising: generating another macro model instead of said macro model when said shape of said macro is rectangle,
wherein in said another macro model, said macro is divided into a plurality of regions and respective metal densities in said plurality of regions are represented in a table form.

7. A program recorded on a computer-readable recording medium and, when executed, causing a computer to perform layout density verification processing,
wherein said layout density verification processing comprises:
generating a macro model for use in metal density check, with respect to a macro included in a layout data; and
performing the metal density check of said layout data by using said macro model,
wherein said macro model includes:
an inner region; and
an outer region surrounding said inner region and located between said inner region and an outer boundary of said macro,
wherein said inner region is masked by metal while a metal layout within said outer region is maintained, and
a width of said outer region inward from said outer boundary of said macro is equal to or larger than a width of one side of a window as a check unit at a time of said metal density check.

8. The program according to claim 7,
wherein said layout density verification processing further comprises: judging, based on said layout data, whether a shape of said macro is rectangle or not,
wherein when said shape of said macro is different from rectangle, said generating said macro model is performed.

9. The program according to claim 8,
wherein said layout density verification processing further comprises: generating another macro model instead of said macro model when said shape of said macro is rectangle,
wherein in said another macro model, said macro is divided into a plurality of regions and respective metal densities in said plurality of regions are represented in a table form.
